(19) United States
(12) Patent Application Publication
(10) Pub. No.: US 2004/0005876 A1
(43) Pub. Date: Jan. 8, 2004

(54) Method and apparatus for limiting and controlling capabilities of a mobile device

(76) Inventor: Samuli Tuoriniemi, Oulu (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/190,342

(22) Filed: Jul. 3, 2002

(51) Int. Cl. H04M 1/66; H04M 1/68; H04M 3/16

(52) U.S. Cl. 455/411; 455/410

(57) ABSTRACT

A mobile device (10) and a corresponding method including a control module (10a) and a data store (10b) of digital rights in respect to optional capabilities, the data store (10b) having for each optional capability an enabled/disabled attribute indicating whether the optional capability is enabled in the device. The control module (10a) receives digital rights structure messages from an entity authorized to configure (or reconfigure) the device by changing the enabled/disabled attribute or by changing the information sufficient for the device to execute an optional capability. The data store (10b) also includes an on/off attribute for use by the owner of the device (10) for temporarily turning off an enabled optional capability, using a password.

### TECHNICAL FIELD

The present invention relates to mobile devices, and more particularly to providing mobile devices in such a way that the devices can be configured or reconfigured to provide different optional capabilities after the devices are manufactured.

### BACKGROUND ART

Mobile devices, and in particular mobile phones, are being provided with more and more capabilities, such as the capability to use short message service (SMS), or to send multimedia messages, or even to access for example a stockbroker over the Internet and buy or sell a stock on-line, i.e. by entering a buy or sell order using a form provided over the Internet, instead of talking to the stock broker. Some capabilities, particularly, those involving the use of the Internet, are of such a nature, that an adult owner of a mobile phone with such capabilities would not want to lend the phone to a child.

From a manufacturing perspective, and for flexibility and responding to different markets, it would be advantageous to make all mobile phones with the same capabilities, some basic and some optional, and to provide a way to enable or disable an optional capability at the point of sale or even afterward. In addition, it would be advantageous, from the adult owner's perspective, to provide such mobile phones with a way for the adult owner to temporarily turn off an enabled optional capability.

### DISCLOSURE OF THE INVENTION

Accordingly, in a first aspect of the invention, a device is provided including at least one optional capability, the device characterized by: a control module, responsive to a message providing an indicated change to a data store holding information on file indicating digital rights in respect to the at least one optional capability, for providing an update to the information on file corresponding to the indicated change provided by the message but only if the message is verified, the control module further responsive to a request from an application for access to the at least one optional capability, and for providing such access but only if such access is authorized by the information on file indicating digital rights in respect to the at least one optional capability; and the data store, for maintaining on file the information concerning the at least one optional capability, and for making available the information on file.

In accord with the first aspect of the invention, the device may be further characterized in that the information on file also includes an enabled/disabled attribute indicating whether the at least one optional capability is enabled or disabled, and in that the update to the information on file is a change to the enabled/disabled attribute of the at least one optional capability. The device may be still further characterized in that the enabled/disabled attribute has an associated parameter indicating a time period during which either the at least one optional capability is enabled or the at least one optional capability is disabled, or has an associated parameter indicating a remaining allowed number of uses of the at least one optional capability.

Also in accord with the first aspect of the invention, the device may be further characterized in that the information on file also includes an on/off attribute for controlling whether the at least one optional capability is temporarily unavailable, and in that the control module (10a) is further responsive to a message, accompanied by a password, indicating a change to the on/off attribute of the at least one optional capability, and also in that the update to the information on file is the change to the on/off attribute of the at least one optional capability. The device may be still further characterized in that the on/off attribute has an associated parameter indicating a time period during which either the at least one optional capability is on or the at least one optional capability is off, or has an associated parameter indicating a remaining allowed number of uses of the at least one optional capability.

Also in accord with the first aspect of the invention, the device may be further characterized in that the information on file includes code implementing the at least one optional capability or a pointer to code implementing the at least one optional capability, and the message includes a patch for patching the code implementing the at least one optional capability.

In a second aspect of the invention, a system is provided including a device according to the first aspect of the invention, and also including a configuring module for providing the message.

In accord with the second aspect of the invention, the system may be further characterized in that the configuring module communicates the message to the device via a wireline.

Also in accord with the second aspect of the invention, the system may be further characterized in that the configuring module communicates the message to the device via wireless communication. Further, the system may also include a radio access network and may be further characterized in that the message is provided wirelessly via the radio access network.

In a third aspect of the invention, a method is provided by which a device is configured to disable or enable an optional capability provided with the device, the method characterized by: a step of providing the device so as to include in a data store the optional capability, and an enabled/disabled attribute indicating whether the optional capability is enabled or disabled; and a step of updating the data store, in response to a message, so as to change the attribute from disabled to enabled but only if the message is verified.

In accord with the third aspect of the invention, the method may be further characterized in that the enabled/disabled attribute has an associated parameter indicating a time period during which either the at least one optional capability is enabled or the at least one optional capability is disabled, or has an associated parameter indicating a remaining allowed number of uses of the at least one optional capability.

In accord with the third aspect of the invention, the method may be further characterized by: a step of providing the device so as to also include an on/off attribute and associated password for making available or making unavailable the optional capability provided that the optional capability is enabled, and so that the device executes the optional capability only if the on/off attribute is on; and a step of changing the on/off attribute to off in response to a message to turn off the optional capability accompanied by a password, but only if the password accompanying the message agrees with the password associated with the on/off attribute provided with the device. Moreover, the method may be still further characterized in that the on/off attribute has an associated parameter indicating a time period during which either the at least one optional capability is on or the at least one optional capability is off, or has an associated parameter indicating a remaining allowed number of uses of the at least one optional capability.

### BRIEF DESCRIPTION OF THE DRAWINGS

The above and other objects, features and advantages of the invention will become apparent from a consideration of the subsequent detailed description presented in connection with accompanying drawings, in which:

FIG. 1A is a block diagram/flow diagram of a mobile device according to the invention, including a data store indicating digital rights in respect to optional capabilities, and showing a user interface and also showing a configuring module used to configure the device by, for example, enabling or disabling optional capabilities (resources) provided with the device;

FIG. 1B is a schematic of the record structure of the digital rights data store (of FIG. 1A);

FIG. 2A is a message sequence diagram in case of an authorized party using the configuring module to initially populate the digital rights data store of records in respect to optional capabilities (i.e. to provide records for each resource/optional capability);

FIG. 2B is a message sequence diagram in case of a user of the device (of FIG. 1A) using the phone user interface to configure the device;

FIG. 3A is a message sequence diagram in case of an application (such as the user interface) requesting use of an optional capability/resource of the device (of FIG. 1A), such as a WAP (wireless access protocol) browser, and the resource then being made available;

FIG. 3B is also a message sequence diagram in case of an application (such as the user interface) requesting use of an optional capability/resource of the device (of FIG. 1A), but where the resource is not enabled and so is not made available; and

FIG. 4 is a flowchart illustrating the operation of a telecommunications device according to the invention.

### BEST MODE FOR CARRYING OUT THE INVENTION

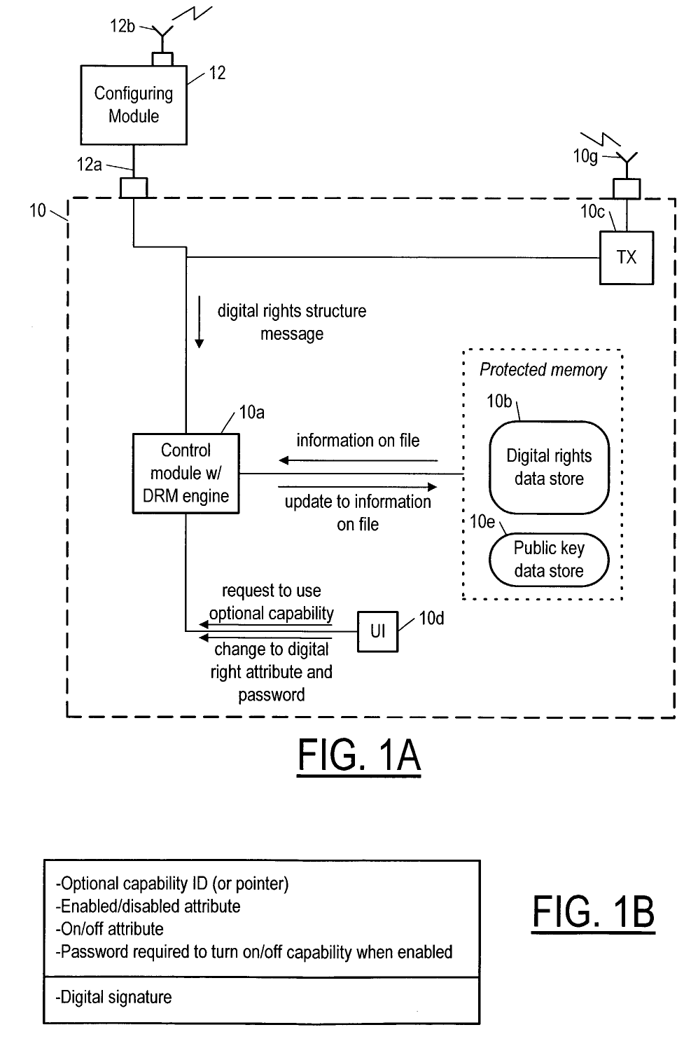

Referring now to FIG. 1A, a mobile device 10 according to the invention is shown as including a control module 10a having a DRM (digital rights management) engine and a data store 10b of digital rights of the device 10 accessible only to the DRM (i.e. in protected memory of the device), including an identification (or a pointer to code) for all possible optional capabilities (or in other words, resources) of the device, only some of which the user of the device will have typically purchased when purchasing the device. A resource or optional capability can be any functionality included in the device 10, either by hardware or by software. The DRM engine enables the device 10 to verify a digital rights structure message indicating a change to a record of the digital rights data store 10b, a digital rights structure message provided for example via a configuring module 12. Preferably, such a message is verified using a public key infrastructure (PKI) trust infrastructure, i.e. using a public key from a certificate authority (CA), a public key that is then also stored in the device, preferably in a public key data store 10e in protected memory. If the message is so verified, the control module 10a accepts the message and makes changes to the digital rights data store 10b (typically enabling or disabling an optional capability) since the sender is authorized to make changes to the data store 10b. DRM technology is normally used to ensure the secure distribution, promotion, and sale of media content on the Internet, but would here be used to restrict access to the data store 10b, as well as to restrict access to the optional capabilities. In the preferred embodiment of the invention, DRM technology is incorporated into the control module 10a to ensure that the control module responds only to messages from entities authorized to configure (or reconfigure) the device 10. Also included in the device 10 is a user interface (UI) 10d by which a user can interface with the control module 10a.

As mentioned, the verification of the digital rights message can be and is preferably done using PKI (Public Key Infrastructure) techniques (e.g. use of digital certificates in connection with DRM), which is well known in the art and not explained here.

Still referring to FIG. 1A, the data store 10b holds (keeps on file), as records for respective optional capabilities/resources included in the device 10, information concerning digital rights for use of the optional capabilities/resources, with the optional capabilities enabled or disabled by the control module 10a according to the digital rights structure messages provided by an authorized entity, such as the original equipment manufacturer (OEM) of the device or a salesperson at the point of sale of the device. The OEM can provide the device with all optional capabilities disabled by setting to disabled the respective enabled/disabled attributes stored in the data store 10b. In executing an optional capability, the control module 10a checks the digital rights data store 10b to determine whether the capability is enabled or disabled. If a capability is disabled, the control module will not let the code implementing the capability be executed (or will not let the operating system trigger or activate the requested resource). The invention is not concerned with how the control module 10b works with the core operating system (not shown) of the device 10 to control access to the data store 10b and to ensure that an optional capability is used only if the digital rights on file allow doing so; how to implement the interface between the control module 10a and the core operating system is a design choice. Preferably, however, an application (such as the user interface 10d) seeking to use an optional capability would attempt to engage the capability the same way for a device in which the present invention is used as in a device where the invention is not used; i.e. the operation of the control module 10a is preferably transparent to applications seeking to use an optional capability, although, of course when an optional capability is not available, such applications would receive a message indicating as much.

Still referring to FIG. 1A, in some embodiments the device 10 is configured at the point of sale by a salesperson using a configuring module 12. Communication between the configuring module 12 and the device 10 is by either wireless communication or wireline communication, and if by wireless communication, can be remote. For wireless communication, the configuring module 12 uses an antenna 12b to send digitally signed messages to an antenna 10 g of the device 10, which are then received in a transceiver 10c within the device and finally provided to the control module 10a (such wireless communication can be either direct or via a radio access network). The messages indicate changes to be made to the data store 10a resulting in a change to the configuration of the device 10. For wireline communication, the configuring module 12 uses a wireline 12a provided with the configuring module 12 to send digitally signed messages to the control module 10a.

Referring now to FIG. 1B, the data store 10b is a data store of digital rights records, digitally signed by the authorized party. A digital rights record structure may include, for example: an optional capability identifier; an enabled/disabled attribute for use in configuring (or reconfiguring) the device by indicating whether the associated capability is enabled or disabled; an on/off attribute for use by the owner of the device in turning on and off an enabled optional capability; and a password required of the operator of the device before allowing access to the on/off attribute of the optional capability. This information may or may not be encrypted. In some embodiments, instead of just an enabled/disabled and an on/off attribute, these attributes can be timed, so as to provide that a digital right is enabled or disabled for some indicated time interval (a duration, a specific time period such as “enabled from Jul. 1, 2002 to Jul. 3, 2002,” or a specific repeating time period such as “enabled from Monday through Wednesday”), or for a specific (remaining) number of times the digital right can be exercised (such as “enabled for 10 more sessions”).

As indicated, in the preferred embodiment, a digital rights message including a command to alter the data store 10b has an associated digital signature (derived from the message), which is used by the control module 10a in determining whether to accept the command to alter the data store 10b of digital rights, as well as in determining the integrity of the digital rights message when checking the digital rights in response to a resource request (i.e. a request from an application to activate or execute an optional capability for which a digital right is kept on file in the data store 10b). Assuming here that each digital rights message indicates a change to only one record (although of course the invention is by no means restricted to such messages), when the control module 10a receives a message in respect to a digital right, the DRM engine verifies the message and the sender of the message using PKI techniques. If both the sender and the integrity of the digital rights message are verified, then the control module 10a makes the change to the data store 10b indicated in the digitally signed message.

Preferably, even though the digital rights (to use optional capabilities) are stored in protected memory (in the digital rights data store 10b), the message and associated digital signature used to last alter/create a digital right are stored in order to guard against attack. Then each time an application attempts to use an optional capability, the digital signature is checked against the digital rights message so as to determine whether the values of the fields of the digital right record for the optional capability correspond to the digital signature, i.e. whether the digital signature is reproducible from the values of the fields.

As examples of the use of the digital rights protection mechanism provided by the invention, a user might use the user interface application 10d to try to execute a JAVA applet, or a Bluetooth application included in the core software of the device might try to access a Bluetooth chip included in the device as an optional capability, and in either case the control module 10a would check the indicated digital right field values to determine whether the digital right is available, and then, to determine whether an attack has been made on the data store 10b, the control module would also verify the integrity of the digital rights message stored in the protected memory. (If the digital rights message is not verified, then the control module disables the optional capability and indicates to the user interface 10d having done so; the user can then ask an authorized entity to restore the digital right. As alternatives to storing the last message and associated digital signature, either the protection mechanism for protecting the data store 10b can be relied on, or a checksum type of tamper detection can be used in which one or more bits are stored with each record indicating a checksum value for the fields of the record.)

Referring again to FIG. 1A, a digital rights structure data flow (conveying a digitally signed message in respect to a digital right to use an indicated optional capability) issued by a salesperson via the point of sale configuring module 12 would typically indicate a change of the enabled/disabled attribute for an optional capability from disabled to enabled. It is also possible and indeed contemplated that a salesperson would use the point of sale configuring module 12 to patch code implementing an optional capability in the device 10 (i.e. install a new code, or overwrite part of the code implementing the capability). After the device 10 is sold and the owner leaves the point of sale, the device may be reconfigured remotely by an authorized entity, such as the OEM, sending digital rights messages to the device 10 via the radio access network 11 (using for example a module analogous to the point of sale configuring module 12).

The device 10 will typically also include base capabilities that are not able to be enabled and disabled. In a preferred embodiment, to allow patching these base capabilities, the control module 10a can be implemented to respond to a message including a patch to a base capability, and to load the patch if the message is verified by the DRM engine of the control module 10a.

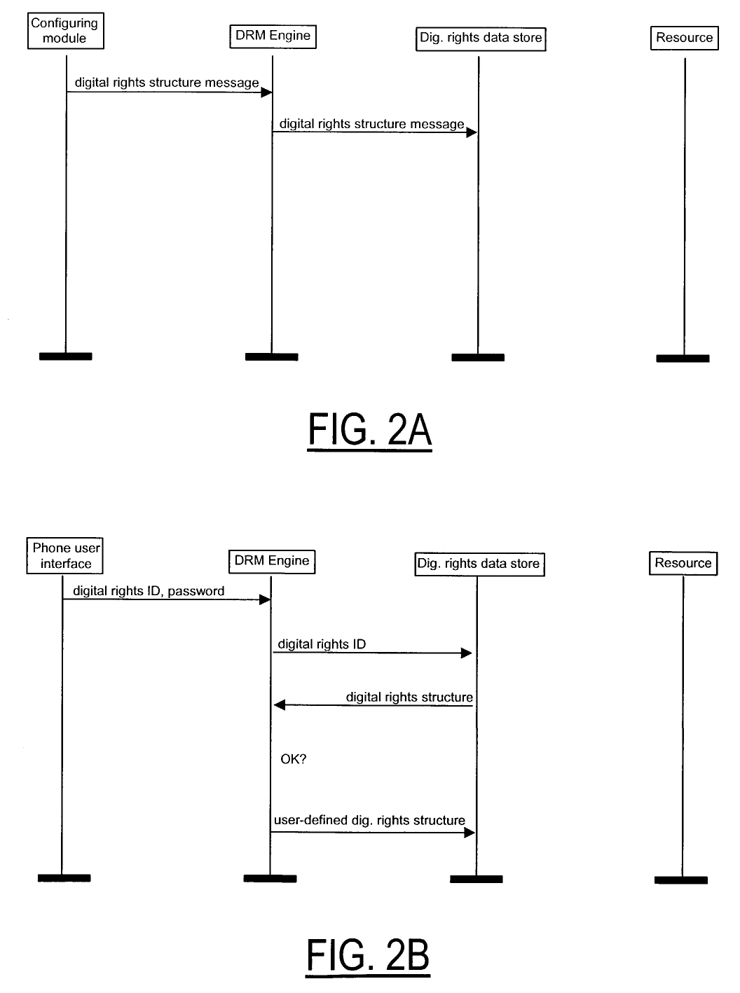

Referring now to FIG. 2A, a message sequence diagram is shown in a scenario in which an authorized party first sets rights to (or provides initial records for) an optional capability (a resource) of the device 10 by sending a message to the device using the configuring module 12 indicating a record to be added to, or changed in the data store 10b to configure the device in respect to the optional capability/resource. In the scenario depicted, the authorized party has earlier provided his public key to the device. Then, as shown in FIG. 2A, the authorized party sends a digital rights structure message providing the record to be added to the digital rights data store 10b. Next, the DRM engine of the control module 10a verifies the message integrity and the message sender authority. If the message is so verified, the control module 10a adds the new record to the digital rights data store 10b (or modifies an existing record).

Referring now to FIG. 2B, a message sequence diagram is shown in a scenario in which a user of the device 10 configures the device in respect to an optional capability. For this scenario, it is assumed that there is an earlier-stored digital rights record for the particular optional capability/resource, i.e. that the digital rights data store 10b includes a record associated with the rights to the optional capability/resource the user wishes to set (typically one record per optional capability) by setting the value of the on/off attribute for the resource. As indicated in connection with FIG. 1B, each record may include the password the user needs to enter in order to turn on or off the respective optional capability. (Alternatively, the digital rights data store 10b could include a single, global password, the same for all optional capabilities, held in only one location in the data store, not in each record.)

According to the scenario illustrated in FIG. 2B (and referring again to FIG. 1), to change the value of an attribute (such as the on/off attribute) for an optional capability (digital right), a user indicates a change to a digital right and provides the corresponding password using the user interface 10d. The request (i.e. the message indicating the change accompanied by the password) is sent to the DRM engine of the control module 10a, which then retrieves from the digital rights data store all or part of the indicated record to determine if, first, the user is allowed to set an attribute of the indicated digital right (resource) by checking that the enabled/disabled attribute is set to enabled, and second, that the password entered by the user agrees with the password in the record for the optional capability/resource. If both conditions are met, the DRM engine changes the resource record by writing to the digital rights data store 10b all or part of the record, as changed. The change to the resource record is conveyed in FIG. 2B by the user-defined digital rights structure message from the DRM engine to the digital rights data store. The DRM engine signs the digital rights structure message (with the user's private key), so that the operation of changing rights is similar to the operation when the change comes via the configuring module 12 (FIG. 1) or via the transceiver 10c from some authorized entity (trusted party) not using a password. In other words, the DRM engine itself is also an authorized entity (trusted party) in that it can also sign a digital rights message using the user's private key, and does so in situations where a user changes a digital right attribute (such as the on/off attribute) by entering only a password. The DRM engine in such a situation constructs a corresponding, signed digital rights message and the digital signature is saved in the protected memory with the new values of the digital right fields.

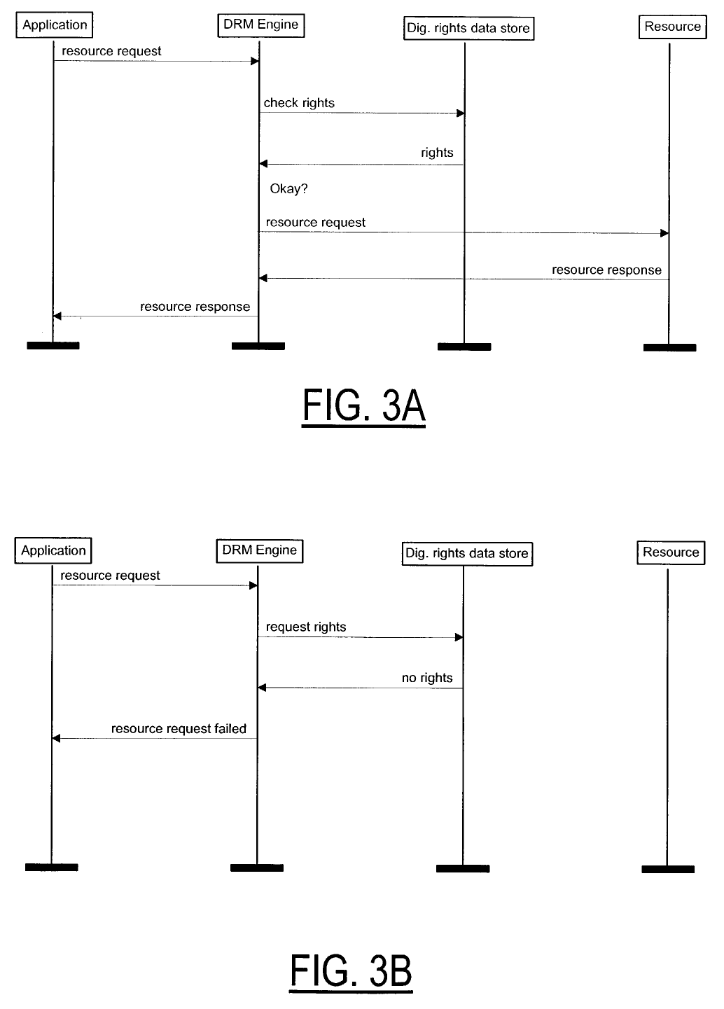

Referring now to FIG. 3A, a message sequence diagram is shown in a scenario in which an application wants to use a specific device resource/optional capability. For example, a user may wish to activate a WAP browser provided with the device, and the user attempts to do so using the UI application 10d. In the scenario, the DRM engine of the control module 10a gets a request from an application to use an optional capability/resource (via the operating system, transparent, preferably, to the requesting application), checks the digital rights data store 10b to determine whether the resource is enabled, and if so, the request is forwarded to the optional capability/resource, which then responds per the request.

Referring now to FIG. 3B, a message sequence diagram is shown in a scenario in which an application wants to use a specific device resource/optional capability, but the resource is not available (enabled). For example, an application wants to use a digital camera that comes with the device, but the digital camera has not been enabled. In the scenario, a request for use of a resource is sent to the DRM engine of the control module 10a. The DRM engine checks whether the resource is enabled, and determines that the resource is currently disabled. The DRM engine then sends a request failed response to the application.

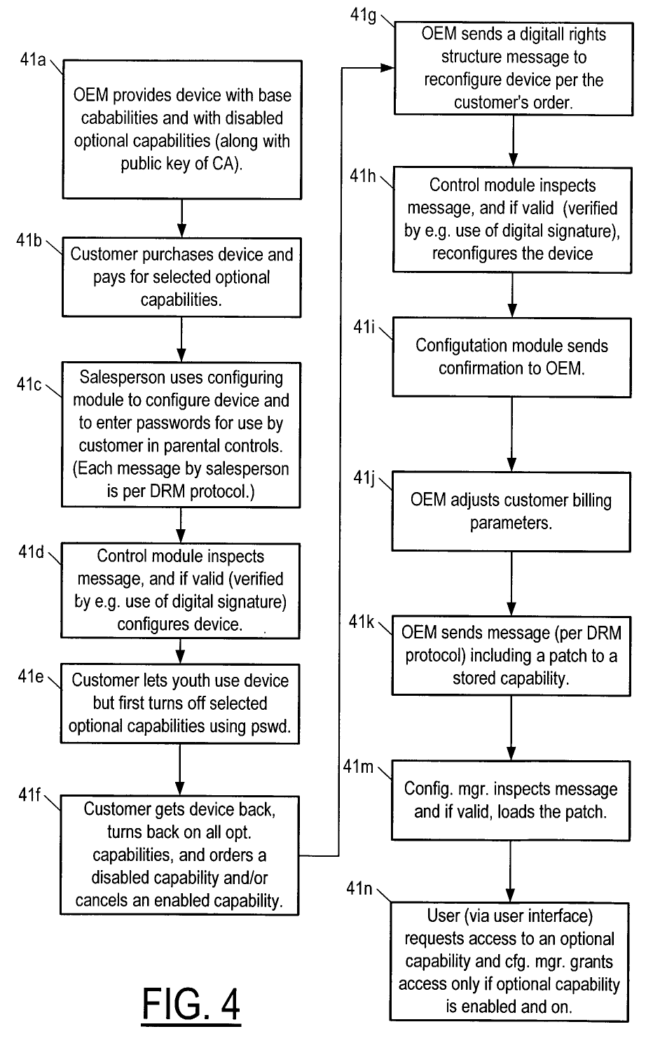

Now referring to FIG. 4, the operation of the device 10 is shown in another scenario illustrating several aspects of the invention, and doing so using a flowchart as opposed to message sequence diagrams. As indicated, the operation of the device according to the scenario includes a first step 41a in which the OEM provides the device with base capabilities and with a number of optional capabilities, all disabled, and, optionally, a password for use by the owner in turning on or off an enabled optional capability (so as for example to exert parental control), the device executing an optional capability only if it is both enabled and on. In addition, the OEM provides a public key of a CA (certificate authority) trusted to issue digital certificates on behalf of either the OEM or some other entity authorized to make changes to the device configuration. In a next step 41b, the customer purchases the device 10 and pays for selected optional capabilities. In a next step 41c, the salesperson uses the configuring module 12 to configure the device and, optionally, to enter a password (or passwords) selected by the customer (as opposed to what is provided by the OEM in step 41a), all of the configuring and password entry being accomplished using messages digitally signed by the sender. (The control module 10a is implemented, in the preferred embodiment, so as to allow the owner of the device 10 to change any of the passwords stored in the data store 10b.) In a next step 41d, the control module 10a verifies the digital rights messages and, if valid, reconfigures the device 10 according to the message(s). After leaving the store, in a next step 41e the customer lets a youth use the device but first turns off selected capabilities, and in a step not shown, the control module 10a alters the data store 10b accordingly, but only if the password(s) used by the owner matches the password(s) in the data store 10b. In a next step 41f, the customer gets the device back from the youth, turns back on all capabilities, and then, via wireless communication with the OEM or an authorized representative (i.e. via the radio access network 31), orders a disabled optional capability and/or cancels an enabled optional capability. In a next step 41g, the OEM or authorized representative wirelessly communicates a digital rights message reconfiguring the device per the customer's order. In a next step 41h, the DRM engine of the control module 10a verifies the message, and, if it is valid, reconfigures the device per the digital rights message. In a next step 41i, the control module 10a wirelessly communicates confirmation to the OEM or authorized representative. In a next step 41j, the OEM adjusts the customer billing parameters. In a next step 41k, the OEM or authorized representative sends a message patching a stored optional capability; such a message would usually be sent over a dedicated control channel, without the customer being aware that a patch command is being received. In a next step 41m, the control module 10a verifies the message providing the patch command, and if valid, accepts the patch, i.e. it writes the patch to the code implementing the indicated optional capability.

### SCOPE OF THE INVENTION

It is to be understood that the above-described arrangements are only illustrative of the application of the principles of the present invention. For example, although the invention is shown and described in the preferred embodiment, in which changes to the digital rights data store 10b are made based on received messages only in case of the messages being verified using PKI techniques, any other relevant security techniques can be used to ensure the sender and the validity of messages indicating changes to the digital rights data store. In addition, numerous other modifications and alternative arrangements may be devised by those skilled in the art without departing from the scope of the present invention, and the appended claims are intended to cover such modifications and arrangements.

What is claimed is:

1. A device (10) including at least one optional capability, the device (10) characterized by:
a control module (10a), responsive to a message providing an indicated change to a data store (10b) holding information on file indicating digital rights in respect to the at least one optional capability, for providing an update to the information on file corresponding to the indicated change provided by the message but only if the message is verified, the control module (10a) further responsive to a request from an application (10d) for access to the at least one optional capability, and for providing such access but only if such access is authorized by the information on file indicating digital rights in respect to the at least one optional capability; and
the data store (10b), for maintaining on file the information concerning the at least one optional capability, and for making available the information on file.

2. The device of claim 1, further characterized in that the information on file also includes an enabled/disabled attribute indicating whether the at least one optional capability is enabled or disabled, and in that the update to the information on file is a change to the enabled/disabled attribute of the at least one optional capability.

3. The device of claim 2, further characterized in that the enabled/disabled attribute has an associated parameter indicating a time period during which either the at least one optional capability is enabled or the at least one optional capability is disabled, or has an associated parameter indicating a remaining allowed number of uses of the at least one optional capability.

4. The device of claim 1, further characterized in that the information on file also includes an on/off attribute for controlling whether the at least one optional capability is temporarily unavailable, and in that the control module (10a) is further responsive to a message, accompanied by a password, indicating a change to the on/off attribute of the at least one optional capability, and also in that the update to the information on file is the change to the on/off attribute of the at least one optional capability.

5. The device of claim 4, further characterized in that the on/off attribute has an associated parameter indicating a time period during which either the at least one optional capability is on or the at least one optional capability is off, or has an associated parameter indicating a remaining allowed number of uses of the at least one optional capability.

6. The device of claim 1, further characterized in that the information on file includes code implementing the at least one optional capability or a pointer to code implementing the at least one optional capability, and the message includes a patch for patching the code implementing the at least one optional capability.

7. A system, including a device (10) as in claim 1 and a configuring module (12) for providing the message.

8. The system as in claim 7, further characterized in that the configuring module (12) communicates the message to the device (10) via a wireline (12a).

9. The system as in claim 7, further characterized in that the configuring module (12) communicates the message to the device (10) via wireless communication.

10. A system as in claim 9, also including a radio access network and further characterized in that the message is provided wirelessly via the radio access network.

11. A method (41) by which a device (10) is configured to disable or enable an optional capability provided with the device, the method characterized by:
a step (41a) of providing the device so as to include in a data store (10b) the optional capability, and an enabled/disabled attribute indicating whether the optional capability is enabled or disabled; and
a step (41d 41h) of updating the data store (10b), in response to a message, so as to change the attribute from disabled to enabled but only if the message is verified.

12. The method of claim 11, further characterized in that the enabled/disabled attribute has an associated parameter indicating a time period during which either the at least one optional capability is enabled or the at least one optional capability is disabled, or has an associated parameter indicating a remaining allowed number of uses of the at least one optional capability.

13. A method as in claim 11, further characterized by:
a step (41a) of providing the device so as to also include an on/off attribute and associated password for making available or making unavailable the optional capability provided that the optional capability is enabled, and so that the device executes the optional capability only if the on/off attribute is on; and
a step (41e) of changing the on/off attribute to off in response to a message to turn off the optional capability accompanied by a password, but only if the password accompanying the message agrees with the password associated with the on/off attribute provided with the device.

14. The method of claim 13, further characterized in that the on/off attribute has an associated parameter indicating a time period during which either the at least one optional capability is on or the at least one optional capability is off, or has an associated parameter indicating a remaining allowed number of uses of the at least one optional capability.
